(19) United States
(12) Patent Application Publication
(10) Pub. No.: US 2016/0203547 A1
(43) Pub. Date: Jul. 14, 2016

(54) Drum Head Display Ordering System

(71) Applicant: Steve KENKMAN, Newcastle, WA (US)

(72) Inventor: Steve Kenkman, Newcastle, WA (US)

(21) Appl. No.: 14/913,456

(22) PCT Filed: Aug. 21, 2014
(86) PCT No.: PCT/US14/52151

§ 371 Date: Feb. 22, 2016

Related U.S. Application Data
(60) Provisional application No. 61/868,489, filed on Aug. 21, 2013.

(51) Int. Cl. G06Q 30/06

(52) U.S. Cl. CPC G06Q 30/0643; G06Q 30/0633

(57) ABSTRACT

A drum head wall display ordering system, comprising a website with a musical performer database containing a plurality of performer files each associated with a performer. Associated with each performer is at least one drum head skin with a graphic printed on the head skin associated with the performer's live performance or a video or audio recording. The website also includes a display style database containing different styles of kick drums or shadow boxes upon which the drum head skin may be mounted. Also discloses is a method for promoting a performer's products or services and fan loyalty using the above system that comprises the steps of visiting the performer's file, selecting a drum head skin with the desired graphic printed on the head skin, selecting a type of display from the display style database, and then transmitting the order to the website operator who then manufacturers the display and delivers the display to the fan.

### TECHNICAL FIELD

The present invention relates to wall displays for memorabilia, and particularly to methods for ordering and purchasing a wall display containing the simulated drum head of a musical band or performer selected from a library of drum heads used by different musical bands.

### BACKGROUND ART

Research on how music is processed by the brain is on going. One important finding is that mental pathways for sounds and music are linked to the listener's visual long term memory. When a listener hears a song popular her or she heard when he or she were younger, images of a strong past event or activity associated with song is immediately presented to the user listener's brain. Alternatively, when a person remembers or visits an important place or activity, the song associated with place or activity is remembered.

Singers and musical bands (called performers) record and sell their music to their fans on recorded media and via digital file downloads from on-line sellers. Associated with each performer is the performer's stage name and a logo or trademark displayed on the recorded media and download website. When playing at a ‘live’ performance, the performer's stage name and logo are usually prominently displayed on or around the stage. If the performer's music is associated with the sound of drums or if the drummer plays an important role in the performance, the base drum is usually position on stage so the front drum skin is visible to the audience. Printed on the drum skin is the performer's stage name and logo.

Fans of performers often collect t-shirts, baseball hats, posters, old ticket stubs and other memorabilia. If the ‘live’ performance was special event (i.e a one time reunion performance by retired band members), the products associated with the special event are sold and become more valuable.

Because music is commonly distributed via digital files downloaded from an online seller, the printed materials once distributed with the record media are no longer distributed and therefore cannot be displayed on the fan's media library shelf, wall or coffee table. Sometimes, the graphic image of the performer or album is delivered with the digital file, but cannot be displayed on the fan's media library shelf, wall or coffee table.

Performers and music promoters are interested in novel ways to promote their products and services that also promotes fan loyalty.

What is needed is a system that allows fans to purchase a display that can be mounted on the wall or displayed on a flat horizontal surface that includes a drum skin depicting the performer's name or a graphic element associated with the performer or a performing event. What is also needed is a system that includes a website that contains a library of replicated drum skins used by different performers that can be selected by a customer and then assembled either into a base drum frame or a shadow box that can be displayed.

### DISCLOSURE OF THE INVENTION

A drum head wall display ordering system, comprising a website with a performer database containing a plurality of performers files. Associated with each performer file is at least one drum head skin. The website also includes a display style database containing different styles of kick drums or shadow boxes upon which the drum head skin may be mounted. A fan may visit the website and select the performer database of his favorite performer and selected a drum head skin. The fan then visits the display style database and selects either a kick drum or a shadow box.

Using the above system, the performer or promoter may promote a performer's products or services and increase fan loyalty. The method comprises the steps of visiting the performer's file, selecting a drum head skin with the desired graphic printed on the head skin, selecting a type of display from the display style database, and then transmitting the order to the website operator who then manufacturers the display and delivers the display to the customer.

### BRIEF DESCRIPTION OF THE DRAWINGS

FIG. 1 is a perspective view of a kick drum display with a performer's drum skin attached thereto.

FIG. 2 is a front elevational view of a shadow box containing a performer's drum skin.

FIG. 3 is an illustration showing a customer selecting and ordering a drum skin display from the system.

FIG. 4 is an illustration of an order page filled out by the fan when ordering a drum skin display.

### BEST MODE FOR CARRYING OUT THE INVENTION

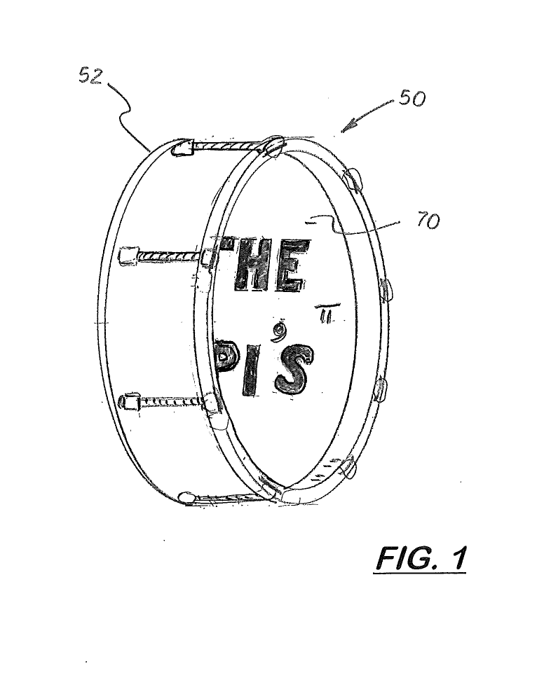

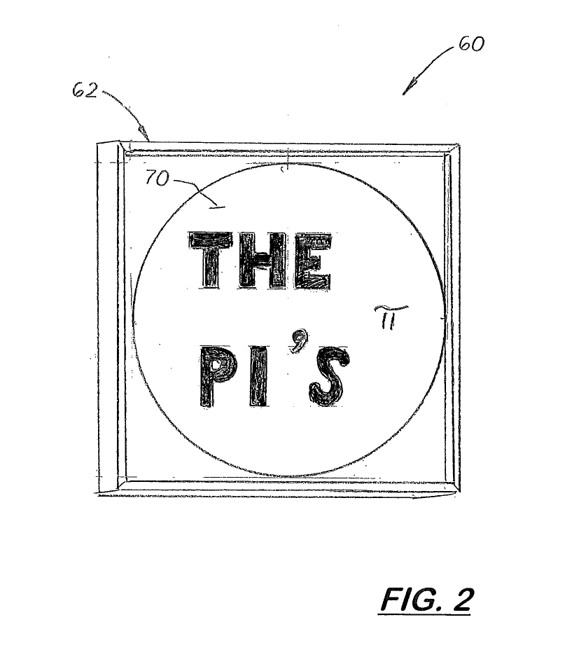

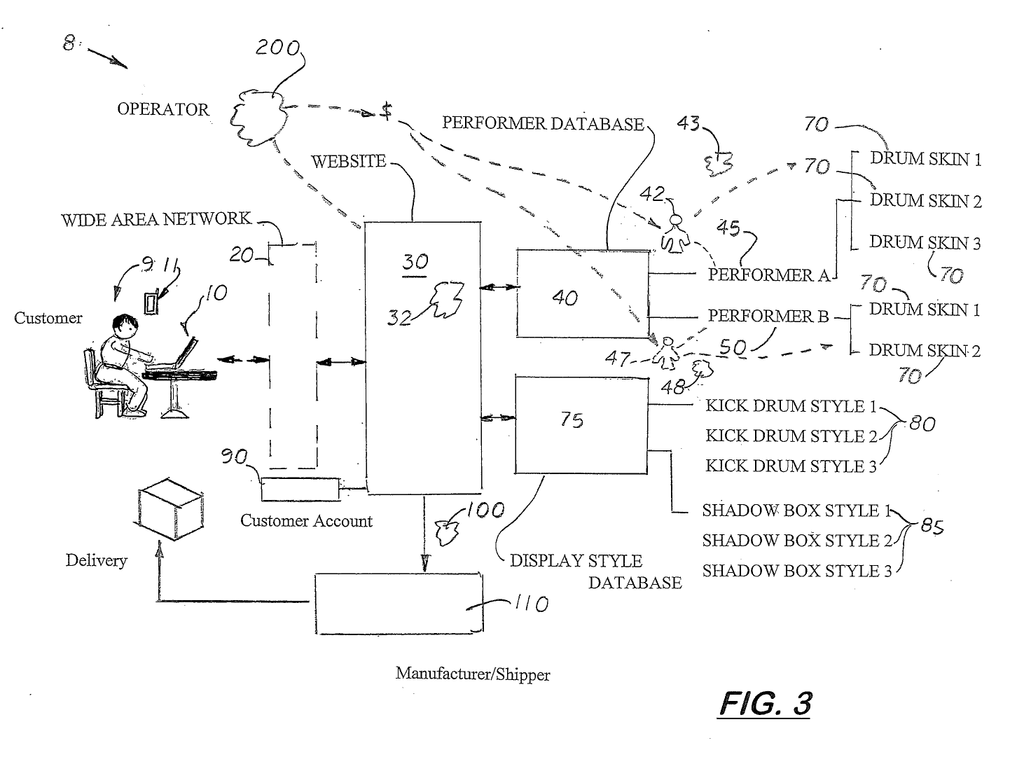

In the accompanying FIGS. 1-4, a drum head wall display ordering system, demoted generally by the reference number 8. The system 8 allows a fan 9 to select a favorite performer from a performer database containing a plurality of performers 42, 47 (musicians, individual singers, bands, actors, actresses, film producers, play produces, television and radio broadcast companies, and on-line media companies). Associated with each performer 42, 47 is a real or replicated drum skin 70 used by or associated with the performer 42,47. The system 8 then allows the fan 9 to select one of two possible static wall displays 50 and 60 shown in FIGS. 1 and 2 in which the drum skin 70 is mounted. The first wall display 50 includes an authentic appearing kick drum cylindrical housing 52 with a drum skin 70 mounted therein. The second wall display 60 includes a square or rectangular housing 62 with the drum skin 70 mounted therein.

More specifically, the system 8 includes a website 30 connected to a wide area network 20. The fan 9 operates a desktop, laptop, or tablet computer (hereinafter known as a computer 10) or a smart phone 11 configured with a necessary network adapters to connect to the wide area network 20. The computer 10 or smart phone 11 has a suitable browser configured to view web pages from the website 30 and input data into an order form 100 page presented to the fan 8.

Connected or linked to the website 30 is a system server 32 connected or linked to a performer database 40 containing a plurality of performers files (shown as Performer A and Performer B, and denoted by reference numbers 45 and 50. Each performance file 45, 50 is associated with a performer 42, 47, respectively. Also, associated with each performer file 45, 50 is at least one replicated drum head skin 70.

The website 30 or system server 32 is linked to a display style database 75 containing at least one kick drum style file 80 and an at least one optional shadow box style file 85. Each file 80 and 85 contains at least one kick drum style and one show box style, respectively.

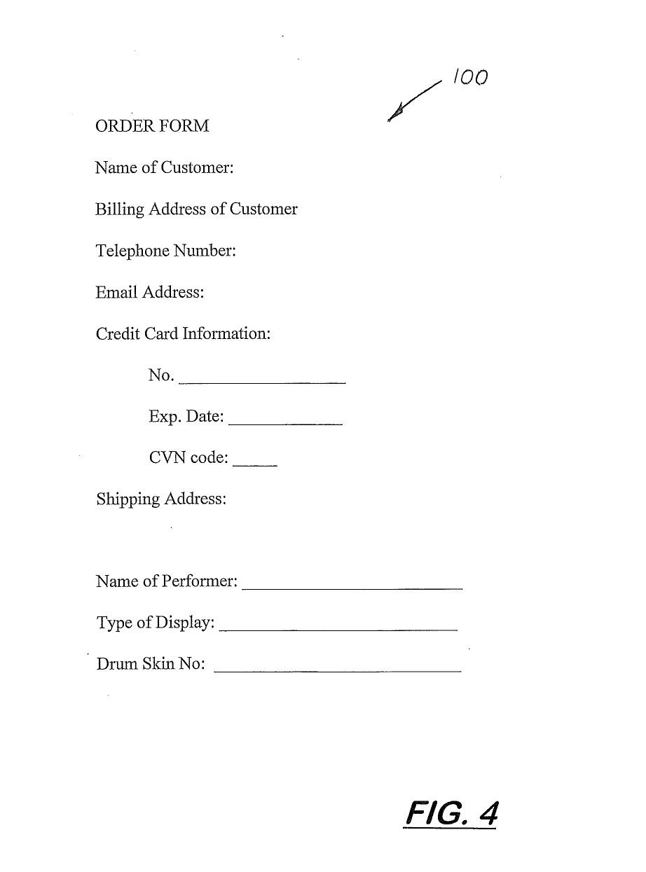

When visiting the website 30, the fan 9 sets up a customer account 90 and visits the performance database 40 and display style database 75 He or she then selects a performer 42, 47 and the performer files A, B, 45, 50, respectively, in the in the performance database 40. The fan 9 then selects a type of display style 80, 85 from the display style database 75. The fan 9 then selects the desired drum skin 70. The selection process includes the completion and submission of an order form 100 shown in FIG. 4 that is presented to the fan 8. After completing and submitting the order form 100, a manufacturer 110, assemblies the display 50 or 60 according to the information submitted on the order form 100. The display 50 or 60 is then delivered to the fan 9.

As stated above, using the above described system 8, the performer 42, or 47 is able to easily promote his or her products or services and increase fan loyalty. The method comprises the steps of creating a performer file 45, 50 on the performer database 40 and then the transmission of a graphic images 43, 48 of one or more drum head skins 70. In one embodiment, the performer 42, 47 then determines of the drum head skin 70 is to be mounted on one or both display styles 80, 85. The performer 42, 47 then gives the manufacturer 110 permission to receive orders from the website 30, produce the drum head skin 0, and attached the drum head skin 70 to the display style 80 or 85. Either the manufacture 110 or the website operator 200 may ship the finish display to the fan 8. The performer 42, 47 then receives a royal payment for each display sold.

In compliance with the statute, the invention described has been described in language more or less specific as to structural features. It should be understood however, that the invention is not limited to the specific features shown, since the means and construction shown, comprises the preferred embodiments for putting the invention into effect. The invention is therefore claimed in its forms or modifications within the legitimate and valid scope of the amended claims, appropriately interpreted under the doctrine of equivalents.

### INDUSTRIAL APPLICABILITY

This invention has application in the decorative wall displays, and more particular to wall displays for display items associated with a performer.

1. A drum head wall display ordering system, comprising;
a. a website;
b. a performer database containing a plurality of performers files, each to said performer file being associated with at least on drum head skin file that replicates the drum head used by the performer;
c. a display style database containing different styles of kick drums or shadow boxes upon which the drum head skin may be mounted.

2. A method for promoting a performer's products or services and fan loyalty using the above system, comprising:
a. selecting a system that includes a website, a performer database containing a plurality of performers files, each said performer file being associated with at least on drum head skin file that replicates the drum head used by the performer, and a display style database containing different styles of kick drums or shadow boxes upon which the drum head skin may be mounted;
b. visiting the website by a customer;
c. selecting a drum head skin with the desired graphic printed on the head skin;
d. selecting a type of display from the display style database;
e. transmitting the order containing the desired graphic and type of display to the website operator who then manufacturers the display;
f. delivering the display to the customer.
